(19) United States
(12) Patent Application Publication
(10) Pub. No.: US 2007/0223412 A1
(43) Pub. Date: Sep. 27, 2007

(54) Method for Signal Transmission in a Radio Communication System

(75) Inventor: Matthias Lott, Neuried (DE)

Correspondence Address: BELL, BOYD & LLOYD, LLP, P.O. BOX 1135, CHICAGO, IL, 60690, US

(73) Assignee: Siemens Aktiengesellschaft, Muenchen (DE)

(21) Appl. No.: 11/568,745

(22) PCT Filed: Feb. 21, 2005
(86) PCT No.: PCT/EP05/50736

§ 371 Date: Nov. 6, 2006

(30) Foreign Application Priority Data
May 5, 2004 (DE) 10 2004 022 145.6

(51) Int. Cl. H04B 7/00

(52) U.S. Cl. 370/310.1

(57) ABSTRACT

The present disclosure relates to a method for signal transmission in a radio communication system, the method using at least two frequency channels and being designed for the transmission of communication between at least two asynchronously operated stations by means of the frequency channels. According to an exemplary method, the stations define a common temporal interval for the communication transmission, for the ready-to-transmit state and/or read-to-receive state, during which an asynchronous data exchange is carried out.

### FIELD OF TECHNOLOGY

The present disclosure generally relates to a method for signal transmission in a radio communication system, in particular in a non-centrally organized radio communication system.

### BACKGROUND

Future radio systems will support very fast data rates so that, for instance, multimedia applications can be operated with a requisite quality of service. A further continual rise in the number of users can also be expected so that further frequency bands will need to be acquired for use by radio systems. However, the efficient use of these frequency bands requires radio systems to operate over a wide frequency range.

Various resource sharing and multiplexing methods are employed in radio systems. As well as by means of multiplexing in the time domain (Time Division Multiplexing, TDM) and in the code domain (Code Division Multiplexing, CDM), different frequency channels are implemented using the FDM (Frequency Division Multiplexing) method. With the FDM method a broad frequency spectrum is divided into a multiplicity of frequency channels that are separated in their frequency range and each have a narrow bandwidth, as a result of which a frequency channel raster defined by the spacing of the carrier frequencies is produced. A plurality of users can thereby advantageously be served simultaneously on different frequency channels and the resources better matched to said users' individual requirements, with adequate spacing between the frequency channels insuring that inter-channel interference can be reduced and controlled.

Services having different quality-of-service (QoS) requirements can furthermore be provided as a result of the separation into a plurality of frequency channels. Higher-priority services will not, in this case, be competing with lower-priority services, as a result of which quality-of-service requirements can advantageously be reliably met through an allocation of resources within frequency ranges.

For the use of narrowband frequency channels by a relevant access method termed FDMA (Frequency Division Multiple Access), transmitters and receivers must in each case select a corresponding carrier frequency in a coordinated manner. Before the relevant resource, which is to say the frequency channel or, as the case may be, radio channel, is used, it is furthermore necessary to check whether the selected resource is already being used by other stations. The resource will then be reserved, with this being made known to other potential stations, where applicable, so they will not thereafter access the resource at the same time and cause collisions. That poses the challenge of making the use of said frequencies as efficient as possible with little effort and, as far as possible, with only one transmitter and receiver (transceiver) per station. An additional boundary condition may be that all stations have equal rights, meaning that no single station assumes control functions over a plurality of stations for assigning the frequency channels.

Particularly in self-organizing networks and networks not having an infrastructure, what are termed ad hoc networks, there are frequently stations that have equal rights and employ the same algorithms and protocols. A known instance of such networks is the wireless local area network (Wireless LAN) conforming to the IEEE 802.11 standard.

If individual stations in such networks are not informed about use of the frequency channels by other stations because relevant information is not collected and distributed by a central station, then one station will be unable to decide which frequency channel it should propose or, as the case may be, select for communicating with another station. Furthermore, one station does not know when another station is ready to receive on which frequency. So one station would, as a rule, be unable to set up a connection to another station if the frequency channels had been selected by both randomly. Moreover, a broadcast made on one frequency would only reach some of the stations that chance to be ready to receive on said frequency.

The use of these orthogonal resources therefore has to be co-ordinated. If, for this purpose, a specific frequency has to be used at fixed, pre-specified times, which is to say all stations are ready to receive on this frequency, then the frequencies parallel thereto cannot be used. Said resources would then be unutilized and unavailable for said stations.

In existing cellular mobile radio systems the frequencies are assigned by a central station, the base station (BS), to the mobile stations (MS) located in a radio cell of the base station. In the GSM (Global System for Mobile communication) system, one central frequency channel per radio cell, for example, is used for emitting general information, which channel is employed by the mobile stations for the purpose of learning about a frequency channel for reporting and requesting resources. If a station, in particular a mobile station, wishes to transmit data, then it will request this from the base station on the frequency channel known to it. The base station will thereupon notify the mobile station of the relevant carrier frequency on which it can communicate with the base station. Assigning and managing of the available resources is controlled centrally in a base station controller (BSC) ranking above the base station and signaled by the base station. The same applies to third-generation UMTS (Universal Mobile Telecommunications System) systems, which likewise signal the assignment of frequencies based on the central approach with the aid of a base station. Owing to the central control, this approach cannot be used in a non-centrally organized system not having a central instance.

Other systems such as, for instance, WLAN (Wireless Local Area Network) systems conforming to the HIPERLAN Type 2 standard, known from, for example, the ETSI/BRAN document “Broadband Radio Access Networks (BRAN); HIPERLAN Type 2 Functional Specification Data Link Control (DLC) Layer; Part 4—Extension for Home Environments, Draft DTR/BRAN-0020004-4, ETSI, Sophia Antipolis, France, April 2000”, or conforming to the IEEE 802.11 standard, employ only a single carrier frequency for communication between two or more stations. Changing to another frequency serves to avoid disruptions due, for example, to the fact that the selected frequency is already being used by other stations. If a new, usable carrier frequency is found, then all stations previously intercommunicating will be changed to said frequency in order to transmit and receive thereon. This method is known in HIPERLAN/2 by the term Dynamic Frequency Selection (DFS). However, the simultaneous, need-dependent use of a plurality of frequencies by any stations for increasing the possible overall capacity of the system or, as the case may be, of an individual connection is not provided. The maximum data rate is thus limited to one frequency channel.

A system is known, similar to the DFS method conforming to the HIPERLAN/2 standard, in which vehicles form groups that use different frequencies, with adjacent vehicles sharing the same carrier frequency. By measuring the active frequency channels it is possible to participate in a plurality of groups simultaneously and to change groups to take account of changing network topologies. It is therein assumed that, as a rule, only one frequency is used by a station for exchanging data while the other frequencies are employed only for receiving in order to prepare for seizure and a possible change of frequency. So that receiving can take place simultaneously on other frequencies it is proposed using two transceivers, one for exchanging data and one for measuring other, potentially usable frequencies. However, a use of a plurality of available frequencies for communicating with adjacent stations for exchanging data is not described herein, either.

A flexible use of the resources including different frequency channels is specified in the DECT (Digital Enhanced Cordless Telephone) cordless telephone standard. The method for using the resources is termed Dynamic Channel Selection (DCS). The allocating of resources is controlled in the system exclusively by one base station in what is termed the “basic mode”, with the relaying of data packets being supported. Available resources are therein checked and seized in a way similar to what happens in a distributed, non-centralized system.

Owing to the special role played by the base station, the mechanisms of the DECT system cannot be applied to non-centrally organized systems. Moreover, DECT does not provide for direct communication between the stations or for setting up a plurality of parallel connections on different frequency channels. Rather it is the case that a station looks for a frequency channel and reduces or, as the case may be, increases the data rate by selecting a number of timeslots.

A method is known from M. Lott, M. Meincke, R. Halfmann, “Exploitation of Multiple Frequency Channels in WLAN”, in Proc. of WIT (Int. Workshop on Intelligent Transportation), Hamburg, Germany, March 2004, wherein for signal transmission in a radio communication system having at least two frequency channels a station accesses one thereof in keeping with a constant time pattern for transmitting and/or receiving signals or, as the case may be, data. In an asynchronous radio communication system of said type each station selects an identical frame size or, as the case may be, duration of a virtual frame and a period for transmitting high-priority messages over a high-priority frequency channel. The start time of such virtual frames can be defined by each station independently. This method guarantees that all important messages will be received by all stations on a coordination frequency no later than after a virtual frame and that any other frequencies can be used simultaneously by the individual stations for communicating among themselves. Each station advantageously needs just one transmitting/receiving device for accessing a single frequency channel, making the stations economical to produce.

What is disadvantageous about this method is the loss of efficiency due to user asynchronicity. According to the method, each station must, for an asynchronous period of absence, change from a frequency channel currently in use to the coordination frequency channel. The duration of the station's absence, meaning the length of time a station is listening on the coordination frequency, is significant in terms of efficiency.

FIG. 4 shows a situation involving ten communicating stations S1-S10 that change to the coordination frequency for a period of time that is 20% of the virtual frame. FIG. 5 shows the corresponding loss of maximum possible data rate, which is to say the resulting throughput rate, with the period of absence shown as the parameter of the various curves. What is thus shown is the throughput rate above the data that is offered on a physical channel for sending and which is actually offered on the radio channel. The value 1 therein corresponds to 100%. It can be seen that for a period of absence of 10 ms (0.1) with a virtual frame lasting 100 ms, thus giving a period of absence of 10%, the result will be an approximately 25% loss of throughput rate compared to a reference operation with no change of frequency. The loss will increase by a further 10% or, as the case may be, 40% if the periods of absence are increased to 20% or, as the case may be, 50% (0.2 or, as the case may be, 0.5).

Assuming a 4-way handshake with a send request or, as the case may be, ready-to-send signal (Request-To-Send/RTS) from a station wishing to send data and with a ready-to-receive signal (Clear-To-Send/CTS) from a station that has received the signal and is ready to receive, there will in this instance be no response in arithmetically 10% of cases. The result will be a doubling of the content window for determining a backoff, which is to say a passivity period, as well as repeated transmission attempts by the sending station after a corresponding time-out. In the worst case the destination station will be absent for the next 10 ms, the result of which will be that a station needing to send will make a multiplicity of renewed transmission attempts and unnecessarily lengthen the backoff window. A mechanism is known from IEEE 082.11 for avoiding congestion and reducing the accessing attempt rate under high-load conditions, and simultaneously reducing the probability of collisions between RTS control packets. In the asynchronous switching scenario the lack of responses will be misinterpreted as congestion. The unsuccessful and ineffective RTS transmissions will furthermore increase the load in the system and consequently reduce the achievable throughput rate.

### SUMMARY

The present disclosure provides efficient uses of a plurality of available frequency channels in a non-centrally organized system. More specifically, an exemplary method is disclosed for signal transmission in an asynchronous radio communication system that provides at least two frequency channels and is designed for a communication transmission between at least two asynchronously operated stations over said frequency channels and where a common time range for the readiness to send and/or receive for an asynchronous exchange of data is defined for the two stations for the communication transmission.

Under another exemplary embodiment, a method is disclosed wherein, prior to the communication transmission, one of the stations emits a ready-to-send signal at varying intervals either decreasing or increasing in time for coordinating the readiness to send or, as the case may be, received.

The exemplary method is advantageous particularly if, after receiving a response from the other station, the emitting station signals its timeframe for matching the timeframe of the other station and/or matches its own timeframe to that of the receiving station. According to a first variant, in said type of procedure the sending station, or, as the case may be, the station wishing to signal or to send data matches itself advantageously in terms of its own timeframe to that of the receiving station. According to a second variant, the receiving station matches its timeframe to that of the sending station. According to a third variant, matching on both sides is also possible, with, for example, the start times of the timeframes being mutually matched, in particular only roughly in view of coordinated common send and receive times with the actual asynchronicity being retained.

The exemplary methods will be advantageous particularly if the longest intervals increasing or decreasing in time are shorter than and/or as long as the duration of reception. The duration of reception corresponds to the time during which stations are ready to receive on a pre-specified frequency for receiving preferably high-priority broadcast packets.

Under yet another exemplary embodiment, a method is disclosed wherein, prior to the communication transmission, for coordinating the readiness to send or, as the case may be, receive one of the stations signals to the other an instant for the start of the communication transmission or of a readiness to receive on a corresponding frequency channel.

Particularly advantageous is an exemplary method wherein, prior to the communication transmission, for coordinating the readiness to send or, as the case may be, receive one of the stations signals to the other one from among the frequency channels that is to be used for the communication transmission.

Also particularly advantageous is an exemplary method wherein, prior to a communication transmission of said type, for coordinating the readiness to send or, as the case may be, receive one of the stations signals to the other a change to a subsequently used frequency channel from among the frequency channels.

Also particularly advantageous is an exemplary method wherein, for coordinating the readiness to send or, as the case may be, receive one of the stations signals to the other an instant of the communication transmission and/or an instant of a change of the frequency channel.

A method of such type will be particularly advantageous if the instant is specified relative to the emission instant of signaling.

A method of such type with signaling will be particularly advantageous if said signaling is conveyed by way of a broadcast packet, data packet, ready-to-send signal, and/or ready-to-receive signal.

Also particularly advantageous is an exemplary method wherein signals for coordinating the communication transmission's readiness to send or, as the case may be, receive are conveyed over a first of the frequency channels and wherein the communication transmission is conducted over another thereof.

Also particularly advantageous is an exemplary method wherein signals for coordinating the communication transmission's readiness to send or, as the case may be, receive are conveyed over a coordination frequency channel from among the frequency channels and wherein the communication transmission is conducted over another thereof.

Also particularly advantageous is an exemplary method wherein the stations are coordinated only for the duration of the communication transmission and/or for the duration of a series of communication transmissions between said stations.

Also particularly advantageous is an exemplary method wherein the stations take into account while the communication transmission is being prepared and/or taking place that the respective other of the stations has a remaining coordination displacement.

Also particularly advantageous is an exemplary method wherein, by way of a communication transmission, a further station not communicating with the communicating stations changes the frequency channel being used and/or changes receive and/or send times asynchronously and in a displaced manner with respect to the communicating stations.

Also particularly advantageous is an exemplary method as claimed in a preceding claim wherein all stations access at least one of the frequency channels according to a time pattern.

Also particularly advantageous is an exemplary method wherein the specific one of the stations and the at least one further thereof employ individual, station-specific time patterns for accessing the frequency channels.

Also particularly advantageous is an exemplary method wherein a non-centrally organized radio communication system is employed as the radio communication system.

Under yet another exemplary embodiment, a station is disclosed; for an asynchronous radio communication system which station is embodied having at least one transmitting/receiving device for randomly accessing in each case one of at least two frequency channels of the radio communication system for sending and/or receiving signals, with the station being configured for a communication transmission that can be temporarily coordinated with another station communicating for the purpose of the communication transmissions discussed above.

An exemplary station having a timer for emitting a ready-to-send signal at varying intervals either decreasing or increasing in time is accordingly particularly advantageous.

An exemplary station having a timer for coordinating the communication transmission's readiness to send or, as the case may be, receive and/or coordinating a change of the frequency channel and for signaling the instant of said change to the other of the stations is accordingly also particularly advantageous.

A use of a plurality of frequency channels with only one transmitting/receiving device in an asynchronous system not having a central instance is advantageously enabled by the inventive methods disclosed herein.

Although the stations themselves are, strictly speaking, still asynchronous, they have nonetheless been roughly synchronized, which is to say they have been brought close to each other in time. This is not synchronizing of the kind necessary for enabling reciprocal data exchanging as would be the case, say, with frame or timeslot synchronizing that would be needed in synchronous systems like GSM, for example. It is rather a matter, here, of coordinating readiness to send or, as the case may be, receive times, and hence of actual “synchronizing” that is thus restricted in scope. The term “synchronizing” will nevertheless also be used for simplicity's sake and for ease of understanding.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 shows exemplary random accessing of two frequency channels by radio stations;

FIG. 2 shows two exemplary frames for a ready-to-send signal or, as the case may be, a ready-to-receive signal;

FIG. 3 shows an exemplary pattern for the accessing of two different frequency channels by two stations according to a second, autonomous embodiment;

FIG. 4 shows a scheme, according to the prior art, for the accessing by a multiplicity of stations of one frequency channel serving to coordinate accessing;

FIG. 5 is a diagram illustrating the throughput rate in the case of such a method according to the prior art;

FIG. 6 shows a scheme, according to the prior art, for accessing the frequency channel for coordinating according to the second embodiment as shown in FIG. 3; and

FIG. 7 is a diagram illustrating the throughput rate in the case of such a method.

### DETAILED DESCRIPTION

What is understood by the term “station” within the scope of the invention is a mobile or stationary user terminal capable of communicating via radio; also a radio station assigned to, for example, a machine. The examples below are based on the following boundary conditions without, though, being restricted thereto. For instance, only one transmitting/receiving unit (transceiver) is used in each exemplary station for implementing the inventive method, which advantageously reduces costs. Transmission media, which is to say frequency channels, are furthermore accessed according to what is known as a random access protocol. Moreover, there is no central instance for centrally controlling resource use, and accessing by a plurality of stations takes place asynchronously, which is to say the stations are not mutually synchronized.

Having randomly accessed one of a plurality of available frequency channels the station sends, for instance, one or more data packets. Having finished sending, the station changes the frequency and receives one or more data packets from another station on another frequency channel. Having finished receiving, the station then accesses a third frequency channel using, for example, random accessing, and sends one or more data packets. Accessing accordingly takes place on a random basis. Owing to the boundary condition of there being only one transmitting/receiving device, the station can either send or receive on the frequency channels. Changing the frequency and switching between sending and receiving are generally associated with a certain time delay.

To avoid wasting capacity or, as the case may be, bandwidth, proposed below with the aid of two exemplary embodiments that can be particularly advantageously implemented in a single, combined embodiment and in conjunction with a non-centralized FDMA system.

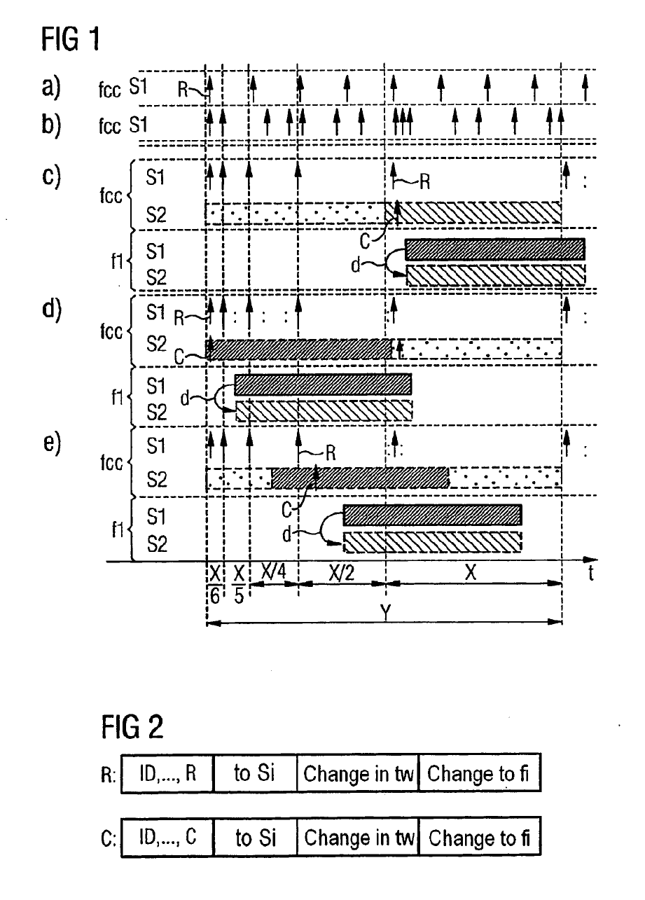

According to the first embodiment a first station S1 sends a ready-to-send signal R in the form of, in particular, a ready-to-send packet (Request-To-Send, RTS) on one frequency channel. This is preferably a coordination frequency channel fcc whose occupancy is illustrated in FIG. 1. Each station accesses said frequency channel fcc at pre-specified time intervals in keeping with a virtual accessing frame that is uniform through-out the system.

The rest of the time the respective station can access any other of the available frequency channels, which is why the time during which the coordination frequency channel fcc is being accessed is referred to below also as the period of absence X. Said period of absence X is a portion less than a duration Y of the frame. The duration of the period of absence X is preferably significantly less than the duration Y of the frame. In the exemplary embodiment shown in FIG. 1 the period of absence X according to variants c)-e) is half the duration X/2 of the duration Y of the frame.

If no ready-to-receive signal C (Clear-To-Send, CTS) is received from another, second station S2 after a ready-to-send signal R has been emitted by the first station S1, then the first station S1 will proceed to repeat transmitting the ready-to-send signal R in order to signal its wish to dispatch data or communicate in some other way.

Repeated transmission of the ready-to-send signal R does not therein take place at discrete, evenly spaced intervals as is illustrated for variant a) and known from “Exploitation of Multiple Frequency Channels in WLAN”, M. Lott, M. Meincke, R. Halfmann, in Proc. of WIT (International Workshop on Intelligent Transportation), Hamburg, Germany, March 2004.

Nor does repeated transmission of the ready-to-send signal R take place on a purely random basis as is illustrated for variant b) and known per se from the IEEE 802.11 standard.

To improve the throughput rate a transmission scheme is used, by contrast, in which repeated transmission of the ready-to-send signal R is based neither on random nor on evenly spaced instants but on intervals increasing or decreasing in time, as is illustrated in FIG. 1 for variants c)-e), proceeding from a period of absence X corresponding, by way of example, to half the duration Y of the virtual frame.

Following a first transmission of a ready-to-send signal R with no ready-to-receive signal C being received, the ready-to-send signal R will be retransmitted at a pre-specified time interval. Said pre-specified time interval corresponds, by way of example, to half the expected period of absence, which is to say X/2 ms. In the case of variants c)-e) the period until transmission is first repeated corresponds only to a sixth the period of absence, which is to say X/6. If a ready-to-receive signal C has still not been received, the ready-to-send signal will be retransmitted yet again, but this time after a longer period, for example a fifth the period of absence, which is to say X/5 ms. Further repeated transmissions will take place after, for example, a quarter the period of absence, which is to say after X/4 ms, after half the period of absence, which is to say X/2 ms, and after the duration of the entire period of absence X. A ready-to-send signal R will thus be emitted by the first station S1 a maximum of six times over the duration Y of a complete frame. The second station S2 must, with the constellation shown, have received the first station's ready-to-send signal R no later than when the sixth ready-to-send signal R has been emitted and, if ready to receive, itself emit a ready-to-receive signal C.

As soon as the first station S1 detects energy, in particular energy above a defined threshold, after a ready-to-send signal R has been emitted, a transmission or, as the case may be, repetition of transmission as specified according to, for example, the IEEE 802.11 standard will be carried out and no further time waited for a repeated transmission delayed in such a way. Following receipt of the ready-to-receive signal C the first station S1 thus initiates the necessary steps for transmitting data over the communication link so that there will be a communication transmission d from the first station S1 to the second station S2. Said communication transmission d is effected preferably on another frequency channel f1 to keep a specific frequency channel free for coordination purposes as the coordination frequency channel fcc.

According to the variant c) the period of absence X of the second station S2, which is to say the time during which the second station S2 is sending or receiving on the coordination frequency channel fcc, is located in the second half of the frame of the first station S1. As a result, the second station S2 only receives the fifth emitted ready-to-send signal R of the first station S1. That signal having been received, the second station S2 sends a ready-to-receive signal C to the first station S1, for which purpose the second station S2 likewise uses the coordination frequency channel fcc. Each time a ready-to-send signal R has been emitted the first station S1 will switch to the receive condition so it can receive such ready-to-receive signals C of another station on the coordination frequency channel fcc.

Of course, the first station S1 can meanwhile also change to another frequency channel in order to receive or send on another of the available frequency channels f1, . . . during the period between the possible receipt of an overdue ready-to-receive signal C in response to a ready-to-send signal R and the emitting of the next ready-to-send signal R.

According to the second illustrated variant, the period of absence X of the second station S2 is at the very start of the duration Y of the virtual frame of the first station S1. The second station S2 will consequently already send a ready-to-receive signal C after a ready-to-send signal R has first been emitted by the first station S1 so that the communication transmission d of data can take place then.

Variant e) shows a case in which the period of absence X of the second station S2, which is to say the time during which the second station S2 is receiving on the coordination frequency channel fcc, will commence temporally displaced after the start of the duration Y of the virtual frame of the first station S2. For this purpose, both stations again change together to another frequency channel, for example to the first frequency channel f1 shown. In view of the asynchronous embodiment of the system, what is therein to be understood by simultaneous changing is optionally also temporally displaced changing of the frequency channel, with a temporal displacement of said kind being accordingly taken into account by both the affected and intercommunicating stations S1, S2.

Variant e) shows a case in which the period of absence X of the second station S2 commences significantly displaced with respect to the start of the duration Y of the frame of the first station S1. The second station S2 accordingly only receives the third repetition of the ready-to-send signal R, whereupon the second station S2 sends back a ready-to-receive signal C to the first station S2. Both stations will thereupon again change in keeping with a pre-specified changeover principle to the first frequency channel f1 for implementing the communication transmission d of data.

Alongside intervals increasing in time for emitting the ready-to-send signal R it is also possible to advantageously employ intervals that decrease in time from long intervals.

Alongside the possibility of immediately initiating a communication transmission d on the same or, preferably, another frequency channel there is, of course, also the possibility of a temporally displaced communication transmission so that said communication transmission will not occur before, for example, the next or next but one or an even later virtual frame. Temporal coordination of the transmission and, where applicable, of a corresponding change of frequency between the communicating stations S1, S2 is very advantageous especially in the case of a communication transmission d temporally displaced in this way. For coordinating of said kind, instants tw of a change or of a start of transmission and/or the frequencies or channel numbers of a frequency channel fj to which changeover is effected are exchanged or, as the case may be, signaled between the stations S1, S2. Signaling of said kind of the instant at which a station is ready to transmit or, as the case may be, changes over to another frequency, and/or of the frequency channel, is the feature of the second exemplary embodiment.

According to the second embodiment, a station Si, i=1, 2, 3, . . . signals to another station Si data used for temporarily synchronizing said stations that are currently intercommunicating or will intercommunicate in a succeeding step. The signaled data can relate to the instant of a communication transmission d of data. The data can additionally or alternatively relate to a frequency or a frequency channel fj used for a communication transmission d of data. Alongside the transmission of instants at which the actual communication transmission d of data begins or takes place, instants of moments are preferably transmitted at which a change of frequency is effected by the signaling station.

The transmission of information described above can take place in a number of manners. According to a first exemplary variant, the information is signaled in piggyback manner. The transmission of the information or, as the case may be, data can therein preferably be signaled as a component of a ready-to-send signal R, of a ready-to-receive signal C, or of an actual data packet of a communication transmission d.

FIG. 2 shows examples of correspondingly embodied data packets. Alongside customary identification data ID and an element identifying it as being a ready-to-send signal R, a ready-to-send signal R optionally also includes, for example, information indicating to which other station S1 this data packet or, as the case may be, ready-to-send signal R is to be sent. The instant tw of an action is also reported, in particular the instant tw of the start of the communication transmission d of actual data and/or of a change to a specific frequency channel fj. The information about the current frequency channel will expediently likewise be co-transmitted if the current frequency channel is retained. Alongside customary identification information ID and an element identifying it as being a ready-to-receive signal C, a ready-to-receive signal C optionally also includes the station Si to which it is directed as well as, depending on the requirements, an instant tw of a change or of a readiness-to-receive and information about a frequency channel fj used in a succeeding step.

The instants tw are preferably coded relative to the emission instant of the relevant packet RC. With a granularity of only one bit, for example, 0.4-ms intervals can be coded in the case of a virtual frame having a duration Y of 100 ms.

According to a second exemplary variant, the instants tw at which a station changes to a specific frequency or, as the case may be, to a specific frequency channel fj, in particular the coordination frequency or, as the case may be, the coordination frequency channel fcc, are reported on a frequency specifically distinguished for the purpose, for example the coordination frequency fcc, by a signaling packet in the manner of a broadcast message.

The alternative embodiments discussed above can advantageously be used mutually independently or in combination. The potential gain of the second embodiment having signaling of frequency switchover instants tw is equivalent to combining the frequency switchover instants. That is to say the instants tw of a change of frequency or, as the case may be, of a frequency switchover are synchronized in the asynchronous system between the participating stations. According to preferred variants, groups of stations S1 intercommunicating or wishing to intercommunicate change the frequency at the same instants tw. “Same instants tw” are to be understood also as referring to time windows that may be necessary in view of the system's asynchronicity.

Stations Si, i=1, 2, . . . not wishing to communicate with the intercommunicating stations advantageously change the frequency at other instants, which is to say deliberately asynchronously, to avoid the risk of collisions.

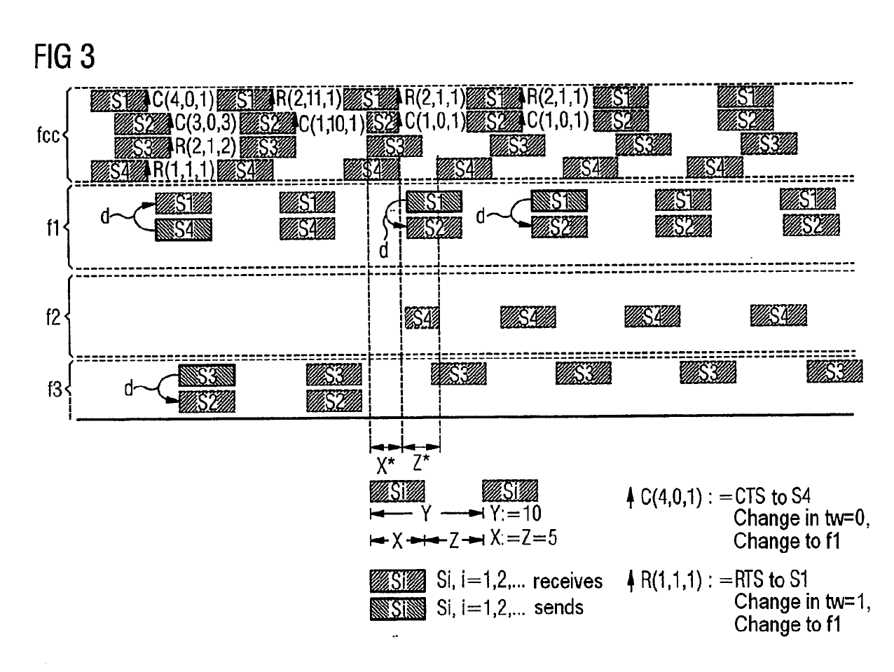

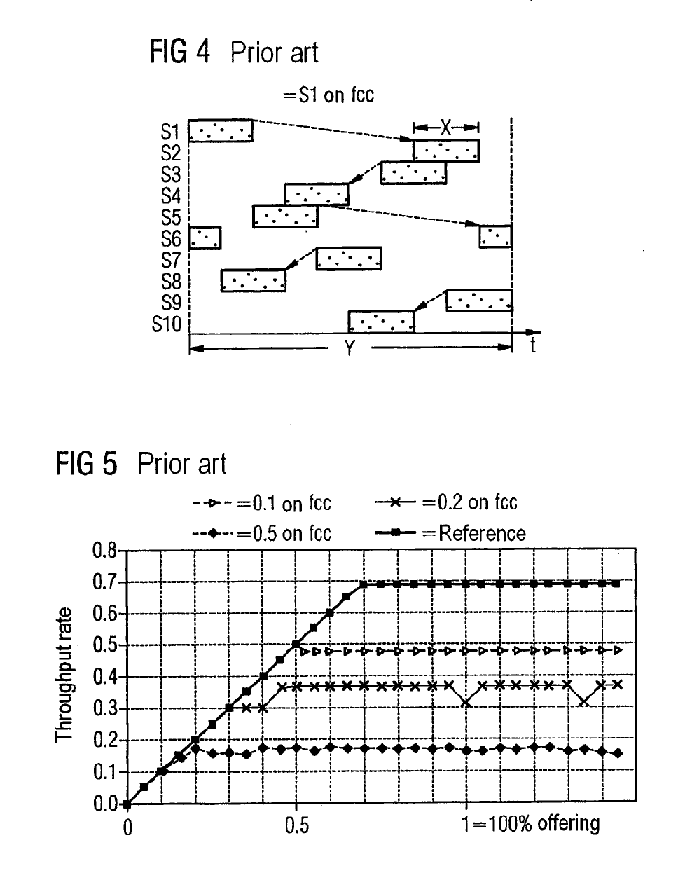

FIG. 3 shows a procedural flow as an exemplary illustration of a variant of the second embodiment. The radio communication system has a coordination frequency channel fcc as a frequency channel fj for coordinating the individual stations Si, i=1, 2, . . . and a multiplicity of frequency channels f1, f2, f3 for an actual communication transmission d of data.

The individual asynchronous stations S1-S4 access the coordination frequency channel fcc in the receive mode in each case for a period of time X corresponding to the period of absence X of the first embodiment within the duration Y of one frame. Accessing advantageously takes place such that each of the stations at least partially exhibits overlapping of the receive time with possible send times of the other stations. What is shown is an exemplary flow of send and receive operations over the time t.

At a first instant a fourth station S4 sends a ready-to-send signal R containing information according to the data packet shown in FIG. 2. The information indicates that the ready-to-send information R of the fourth station S4 is directed at the first station S1 and informs it that the fourth station S4 will execute a communication transmission d in the first frequency channel f1 after one time unit. In response, the first station S1 sends a ready-to-receive signal C containing information according to the data packet shown in FIG. 2. Said information is accordingly directed at the fourth station S4 and informs it of the readiness to receive of the first station S1 in zero time units on the first frequency channel f1. Both stations S1, S4 then change to the first frequency channel f1 on which the fourth station S4 begins the communication transmission d for transmitting data to the first station S1.

At an instant temporally displaced relative to the first and fourth station S1, S4, corresponding signaling takes place in the communication frequency channel fcc between a third and a second station S3, S2, with the exchange of a ready-to-send signal R and a ready-to-receive signal C followed by a communication transmission d in the third frequency channel f3 between said stations S3, S2. It is of course alternatively also possible according to further variants to partially or completely omit the emitting of a ready-to-receive signal C of said the abovementioned type.

According to the embodiment, intercommunicating stations change back, for receiving again, to the coordination frequency channel fcc no later than on expiration of the duration Y of the virtual frame of the station whose duration Y of the virtual frame expires first. This will insure that each individual station can be reached over the coordination frequency channel fcc from any other station S1 within the duration Y of a virtual frame so that emergency signals or high-priority data can be relayed as quickly as possible. However, according to alternative embodiments it is in principle also possible and advantageous to change to another frequency fj for a communication transmission d of longer duration than the duration Y of one timeframe.

It is assumed in the exemplary procedural flow that no directly following data transmissions will take place after the two communication transmissions d on the first or, as the case may be, third frequency channel f1, f3. It is assumed that the first station S1 will convey data to the second station S2 with a temporal displacement. The first station S1 accordingly sends the second station S2 a ready-to-send signal R within the period of time during which said first station remains in the coordination frequency channel FCC. What is also reported is that the first station S1 intends effecting a communication transmission d on the first frequency channel f1 after eleven time units tw. The second station S2 sends a corresponding ready-to-receive signal C to the first station S1 and confirms its readiness-to-receive after ten time units on the first frequency channel f1. The instant tw having in this example been chosen as being later than the duration Y of one frame, both stations S1, S2 will again first go to the coordination frequency channel fcc. After any further signaling that may be necessary, said two stations S1, S2 will change to the first frequency channel f1 for the communication transmission d.

Because the virtual timeframe of the second station, S2 begins significantly later than that of the first station S1, the second station S2 will interrupt the period of absence X after a curtailed period of absence X*, which is to say after a curtailed readiness-to-receive on the coordination frequency channel fcc, and change prematurely to the first frequency channel S1, with the second station S2 preferably matching its own virtual timeframe in terms of the starting instant thereof to that of the first station S1 so that said two stations S1, S2 will be synchronized relative to each other from said instant onwards.

There may be a residual displacement in terms of said synchronizing. The matched synchronizing can, according to other variants, also be retained until a later matching operation.

What is preferred are exemplary embodiments where, during a communication transmission d between two or more stations S1, S2, further stations, for example the fourth station S4, that are not involved in said communication transmission d, change to another frequency band f2 and/or perform temporally displaced synchronizing of their virtual timeframe. In the variant embodiment shown, the fourth station S4 meanwhile changes owing to the intended communication transmission d of the first and second station S1, S2 to the free second frequency band f2. The fourth station S4, which was synchronized by the earlier communication transmission d with the first station S1, moreover recognizes that it is expedient to resynchronize its virtual timeframe. The fourth station S4 accordingly changes back at an earlier instant after a curtailed period of time Z* to the coordination frequency channel fcc and also re-matches the start of the duration Y of its own virtual timeframe accordingly. The fourth station S4 will as a result become asynchronous in terms of its virtual timeframe relative to the virtual timeframes of the first and second station S1, S2.

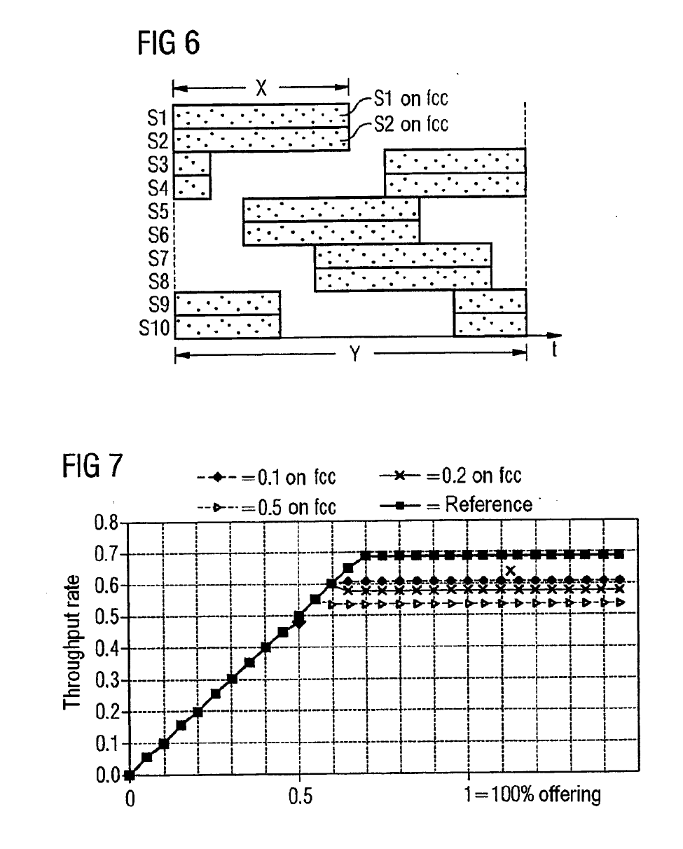

FIG. 6 shows a variant exhibiting a combination of both embodiments. A total of ten stations S1-S10 communicate in an asynchronous radio communication system having one coordination frequency channel fcc and a multiplicity of frequency channels fj serving to effect actual communication transmissions of data. Outlined in the variant shown is the sequence of operations over the time t for the duration Y of one virtual frame length. The period of absence X is shown as a dotted box for each of the ten stations. The period of absence X is again to be understood as the time during which the individual stations S1-S10 are not on one of the frequency channels for sending or receiving but on the coordination frequency channel fcc. The period of absence X is, by way of example, 50% of the duration Y of the virtual frame. The individual virtual frames of the various stations S1-S10 are advantageously mutually asynchronous, with respectively intercommunicating communicating stations S1, S2; S3, S4; S5, S6; S7, S8; S9, S10 being mutually synchronized.

The attainable throughput rate in the case of an asynchronous non-centralized FDMA method of said type exhibiting a temporary synchronizing of intercommunicating stations is illustrated in FIG. 7, with the various curves outlining the throughput rate as a function of the duration of the respective period of absence X. It can be seen that the attainable throughput rate is virtually independent of the duration of the period of absence X. Moreover, the loss compared to the case, shown as a reference curve, in which no change of frequency takes place, is only minimal. The gains in throughput rate compared to asynchronous and uncoordinated operation as shown in to FIG. 5 are clearly apparent.

What is accordingly advantageous is in particular an asynchronous non-centralized radio communication system or, as the case may be, a method for operating stations in a system of said kind wherein a frequency changeover pattern is pre-specified that exhibits defined frequency changing, with the stations of the asynchronous system changing between the available frequencies. The instants tw at which a station Si changes the frequency fj is furthermore signaled so that, in the final analysis, signaling of the frequency changeover pattern is performed. Stations wishing to intercommunicate advantageously select identical instants tw for a change of frequency. Stations not wishing to intercommunicate advantageously select different instants so as to use the available transmission resources as evenly as possible. Although the intervals for receiving and sending are therein advantageously pre-specified throughout the system, they can vary relative to each other. In particular the starting points of virtual transmission frames can be matched in terms of the starting time relative to other stations' virtual transmission frames.

This type of system offers numerous advantages. In an asynchronous system the use is enabled of a multiplicity of frequency channels fcc, fj, j=1, 2, . . . with only one transceiver without requiring the existence of a central instance. Receiving and sending on channels having different priorities is enabled by the method employed. Moreover, it can be guaranteed that specific signals or messages can be received by all stations within a defined time. The remaining channels can be used during the periods when stations do not have to operate on higher-priority channels and/or a coordination frequency channel. In the exemplary embodiments shown here the coordination frequency channel fcc is, for example, a kind of higher-priority channel, while the other frequency channels fi, i=1, 2, 3 constitute non-prioritized channels, although further prioritized channels can also be used.

The system's asynchronicity does not adversely affect the functionality of the method. On the contrary, no phases occur during which individual channels have to remain unutilized, because each station can freely select the temporal position of its operating phases on the prioritized channels within the period under consideration of the duration Y ms of the virtual timeframe.

Coordinating the changeover instants or, as the case may be, coordinating changing between different frequency channels fcc, f1 brings a significant efficiency enhancement compared to asynchronous operation to which this kind of method is not applied. A plurality of frequencies can be used simultaneously with no significant losses in throughput rate compared to a system that requires a plurality of transceivers per station to be able to operate with a plurality of frequency channels.

The period of absence X has a virtually negligible impact on the efficiency of the method. The asynchronicity of different groups formed from intercommunicating stations allows all frequency channels fj to be exploited through statistical multiplexing. Another station or group can use the relevant frequency channel at times when one group is absent from a frequency channel fj.

Individual stations are mutually synchronized, not compulsorily though advantageously, according to a pattern, taking account of a virtual frame that is uniform throughout the system. Said pattern thus establishes for a station when and how often it has to receive within the virtual frame on frequency channels having higher-priority data or, as the case may be, signals, and when and for how long it has to emit correspondingly prioritized data or, as the case may be, signals. Although the time intervals between sending and receiving are, for example, pre-specified throughout the system, they can vary relative to each other.

The methods disclosed herein can advantageously be realized in the DSRC (Dedicated Short Range Communication) system currently being standardized. The purpose of the DSRC system is to enable digital communication between vehicles and highway verges as well as reciprocally between vehicles. It will be used both in safety applications, for example forwarding hazard warnings, and in private sector or, as the case may be, public sector applications such as, for example, collecting road tolls or accessing the internet from a vehicle etc.

The 802.11 IEEE standard is scheduled as the basis for the DSRC system's radio access, although this standard is to be expanded as part of the standardizing process into what is termed a Road Access Standard 802.11aR/A. As shown in FIG. 5, the system makes seven frequency channels available in the 5,850 to 5,925 MHz frequency spectrum, with one of said frequency channels being defined as a control channel to be used predominantly for transmitting messages relevant to safety such as, for example, hazard warnings. The other frequency channels will serve as service channels for transmitting other data, for example for controlling traffic flows, communicating between vehicles, or collecting road tolls. The control channel is to be used also for announcing the time, nature, and scope of said messages. Messages relevant to safety are characterized by a periodically repeated emission that will insure their reception by the vehicles.

Medium access controlling (MAC: Medium Access Control) within the channels takes place randomly according to the known CSMA/CA (Carrier Sense Multiple Access/Collision Avoidance) method of the IEEE-802.11 standard. This means that accessing takes place asynchronously and on a non-centralized basis with no controlling by a central instance.

The methods disclosed herein can also be realized in a DSRC system preferably providing FDMA operation for systems on the basis of IEEE 802.11a, for example according to the exemplary embodiments above. The frequency channel having the highest priority would accordingly be the DSRC system's control channel fcc, and the frequency channel f1 having the next lower priority would be the channel for public safety-related applications. Other channels are all non-prioritized and would thus correspond to the second or third frequency channel f2, f3 in the above examples.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-20. (canceled)

21. A method for signal transmission in a radio communication system, the method comprising the steps of:
making available at least two frequency channels for a communication transmission between at least two asynchronously operated stations;
defining a common time range is for the communication transmission between the at least two stations; and
performing an asynchronous data exchange between the at least two asynchronously operated stations.

22. The method as claimed in claim 21, wherein prior to the communication transmission, a first of the at least two stations emits a ready-to-send signal at varying intervals decreasing or increasing in time for coordinating a readiness to send and/or receive.

23. The method as claimed in claim 22, wherein after receiving a response from a second of the at least two stations, the first station signals a timeframe for matching the timeframe of the second station or matching its own timeframe to that of the second station.

24. The method as claimed in claim 22, wherein the longest intervals increasing or decreasing in time are equal or shorter than a duration of reception.

25. The method as claimed in claim 22, wherein for coordinating the readiness to send and/or receive, prior to the communication transmission, the first station signals to the second station an instant for the start of the communication transmission or of a readiness-to-receive.

26. The method as claimed in claim 22, wherein for coordinating the readiness to send and/or receive, prior to the communication transmission the first station signals to the second station a frequency channel from among the frequency channels that is to be used for the communication transmission.

27. The method as claimed in claim 22, wherein for coordinating the readiness to send and/or receive, prior to the communication transmission the first station signals to the second station a change to a frequency channel from among the frequency channels that is to be used in a succeeding step.

28. The method as claimed in claim 22, wherein for coordinating the readiness to send and/or receive the first station signals an instant of the communication transmission and/or an instant of a change of the frequency channel to the second station.

29. The method as claimed in claim 28, wherein the instant is selected relative to an emission instant of signaling.

30. The method as claimed in claim 22 wherein signaling is conveyed by one of a broadcast packet, data packet, ready-to-send signal, and ready-to-receive signal.

31. The method as claimed in claim 22, wherein signals for coordinating the readiness to send and/or receive of the communication transmission are conveyed over a first frequency channel from among available frequency channels and the communication transmission is conducted over another frequency channel from among the frequency channels.

32. The method as claimed in claim 22, wherein signals for coordinating the readiness to send and/or receive of the communication transmission are conveyed over a coordination frequency channel from among the frequency channels and the communication transmission is conducted over another frequency channel from among the frequency channels.

33. The method as claimed in claim 21, wherein the stations are coordinated only for at least one of (1) the duration of the communication transmission and (2) for the duration of a series of communication transmissions between the stations.

34. The method as claimed in claim 33, wherein the stations take into account, while the communication transmission is being prepared and/or taking place, that the respective other of the stations has a remaining coordination displacement.

35. The method as claimed in claim 21, wherein, by way of a communication transmission, a further station, not communicating with the first and second station, changes the frequency channel being used and receive/send times asynchronously and in a displaced manner with respect to the intercommunicating stations.

36. The method as claimed in claim 21, wherein the stations access at least one of the frequency channels according to a time pattern.

37. The method as claimed in claim 21, wherein the first station and at least the second station employ individual, station-specific time patterns for accessing the frequency channels.

38. A station for a radio communication system, comprising:
at least one transmitting/receiving device for accessing one of at least two frequency channels of said radio communication system, wherein the at least one transmitting receiving device processes a common time range for communication transmission to another station and performs an asynchronous data exchange with the other station based on the processing.

39. The station as claimed in claim 38, further comprising a timer for emitting a ready-to-send signal at varying intervals decreasing or increasing in time.

40. The station as claimed in claim 39 wherein the timer coordinates a readiness to send and/or receive of the communication transmission.

41. The station as claimed in claim 39 wherein the timer controls a change of the frequency channel and for controlling a signaling of the instant of said change to the other station.
